(19) United States
(12) Patent Application Publication
(10) Pub. No.: US 2014/0129285 A1
(43) Pub. Date: May 8, 2014

(54) SYSTEMS AND METHODS FOR EFFICIENT WORKFLOW SIMILARITY DETECTION

(71) Applicant: XEROX CORPORATION, Norwalk, CT (US)

(72) Inventors: Changjun Wu, Rochester, NY (US); Hua Liu, Fairport, NY (US)

(73) Assignee: XEROX CORPORATION, NORWALK, CT (US)

(21) Appl. No.: 13/670,733

(22) Filed: Nov. 7, 2012

(51) Int. Cl. G06Q 10/06

(52) U.S. Cl. 705/7.27

(57) ABSTRACT

The present invention generally relates to systems and methods for comparing workflows. More particularly, the invention relates to thinning a number of workflow pairs to compare, prior to conducting a detailed comparison among pairs of workflows. The invention can be used to generate a workflow similarity graph based on a large set of workflows.

### FIELD OF THE INVENTION

This invention relates generally to comparing workflows.

### BACKGROUND OF THE INVENTION

Workflows can model real-world tasks and transitions between tasks. Comparing workflows, particularly large sets of workflows, to detect workflows that are similar to each-other can be a computationally intensive task.

### SUMMARY

According to an embodiment, a system for, and method of, detecting similar workflows is disclosed. The system and method obtain a plurality of workflows, each workflow including a plurality of tasks and a plurality of operations; decompose each workflow into a plurality of components, each component including a plurality of tasks; serialize each component into strings, each string including a sequence of tasks, such that a plurality of serialized components are produced; sort the plurality of serialized components, such that a plurality of sorted serialized components are produced; n-level bucket the plurality of serialized components, where n≧2, such that a plurality of bucketed sorted serialized components are produced; use the plurality of bucketed sorted serialized components to obtain a plurality of pairs of workflows; compare workflows in each pair of workflows to determine workflow similarity; and provide pairs of similar workflows based on the comparing.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 is a schematic diagram of a system according to some embodiments;

FIG. 2 is a schematic diagram of a workflow and its components;

FIG. 3 is a flow chart of a method according to some embodiments;

FIG. 4 is a schematic diagram of applied processing steps according to some embodiments;

FIG. 5 is a schematic diagram of applied processing steps according to some embodiments; and

FIG. 6 is a schematic diagram of a workflow similarity graph.

### DESCRIPTION OF THE EMBODIMENTS

Reference will now be made in detail to the present embodiments (exemplary embodiments) of the invention, examples of which are illustrated in the accompanying drawings. Wherever possible, the same reference numbers will be used throughout the drawings to refer to the same or like parts. In the following description, reference is made to the accompanying drawings that form a part thereof, and in which is shown by way of illustration specific exemplary embodiments in which the invention may be practiced. These embodiments are described in sufficient detail to enable those skilled in the art to practice the invention and it is to be understood that other embodiments may be utilized and that changes may be made without departing from the scope of the invention. The following description is, therefore, merely exemplary.

While the invention has been illustrated with respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” The term “at least one of” is used to mean one or more of the listed items can be selected.

Workflows model real-world tasks and the transitions between them. For example, a workflow can model constructing a building, paying employees, purchasing items online, etc. Large enterprises typically include many different, and possibly related, workflows. For example, workflows can partially overlap, e.g., the workflow for manufacturing a base model car can overlap the workflow for manufacturing a car with extensive upgrades.

In general, a workflow can be conceptualized as a finite set of activities, or “tasks”, paired with a finite set of operations. The set of activities traditionally includes a start task and an end task. The set of operations includes transitions between two tasks, splits from one task to two or more tasks, and joins (a.k.a. “merges”) from two or more tasks to one task. The operations can be considered as transitions or flows from one (or more) tasks to one (or more) tasks.

Comparing workflows for similarity can be computationally expensive. For example, one way to do so is to use brute-force pairwise comparisons. Another comparison technique, detecting sub-graph isomorphism between arbitrary workflows, is an NP-complete problem, which is generally considered intractable. Accordingly, comparing large sets of workflows to detect clusters of similar workflows would benefit from reducing computational requirements.

Embodiments of the present invention can be used to detect similar workflows. More particularly, embodiments can be used to filter out dissimilar workflows, so that a more precise and computationally intensive comparison can be performed on the remaining workflows. Some embodiments accomplish this by filtering out workflows that do not have sufficient numbers of joins and merges in particular places in common with the workflow to which they are to be compared. This process is detailed below in reference to the figures.

Embodiments of the invention can be used to generate a workflow similarity graph (also known as a “workflow relationship graph”) for an arbitrary set of workflows. In a similarity graph, each node represents an entire workflow. An edge between two nodes indicates that the nodes are sufficiently similar according to a chosen similarity metric. Similarity graphs can be used to detect clusters of similar workflows.

Workflow similarity graphs, and workflow comparisons in general, have many useful applications. For example, after constructing a similarity graph, a business analyst can identify the relationships among a given set of workflows. The business analyst can utilize computations to detect if there are any duplicated workflows in the system. Also based on the graph, the business analyst could perform a clustering detection computation and identify the hierarchy of the workflows. This hierarchy can help the business analyst to manage the individual workflows. As another example, similarity graphs can be used for workflow recommendation, that is, automatically recommend historical efficient workflows to customers based on their existing workflows. Other applications of workflow comparison and similarity graphs are also contemplated.

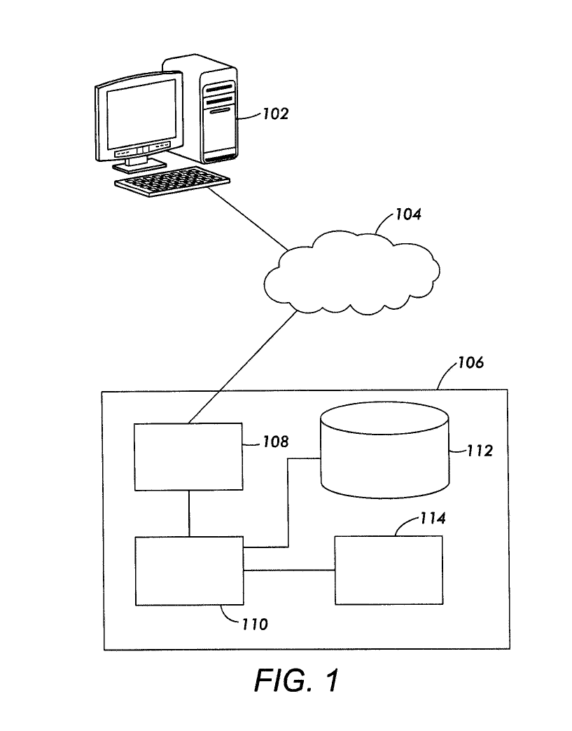

FIG. 1 is a schematic diagram of a system according to some embodiments. In particular, FIG. 1 illustrates various hardware, software, and other resources that may be used in implementations of computer system 106 according to disclosed systems and methods. In embodiments as shown, computer system 106 may include one or more processors 110 coupled to random access memory operating under control of or in conjunction with an operating system. The processors 110 in embodiments may be included in one or more servers, clusters, or other computers or hardware resources, or may be implemented using cloud-based resources. The operating system may be, for example, a distribution of the Linux™ operating system, the Unix™ operating system, or other open-source or proprietary operating system or platform. Processors 110 may communicate with data store 112, such as a database stored on a hard drive or drive array, to access or store program instructions other data.

Processors 110 may further communicate via a network interface 108, which in turn may communicate via the one or more networks 104, such as the Internet or other public or private networks, such that a query or other request may be received from client 102, or other device or service. Additionally, processors 110 may utilize network interface 108 to send information, instructions, workflow relationships, workflow relationship graphs, or other data to a user via the one or more networks 104. Network interface 104 may include or be communicatively coupled to one or more servers. Client 102 may be, e.g., a personal computer coupled to the internet.

Processors 110 may, in general, be programmed or configured to execute control logic and control operations to implement methods disclosed herein. Processors 110 may be further communicatively coupled (i.e., coupled by way of a communication channel) to co-processors 114. Co-processors 114 can be dedicated hardware and/or firmware components configured to execute the methods disclosed herein. Thus, the methods disclosed herein can be executed by processor 110 and/or co-processors 114.

Other configurations of computer system 106, associated network connections, and other hardware, software, and service resources are possible.

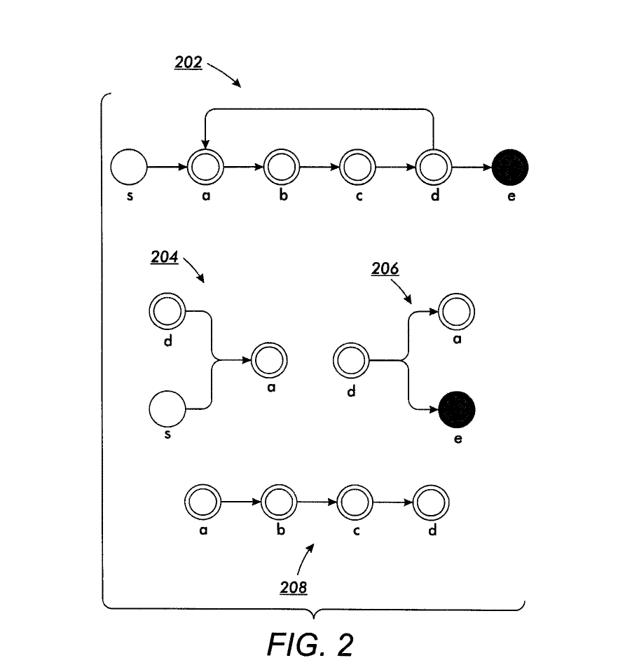

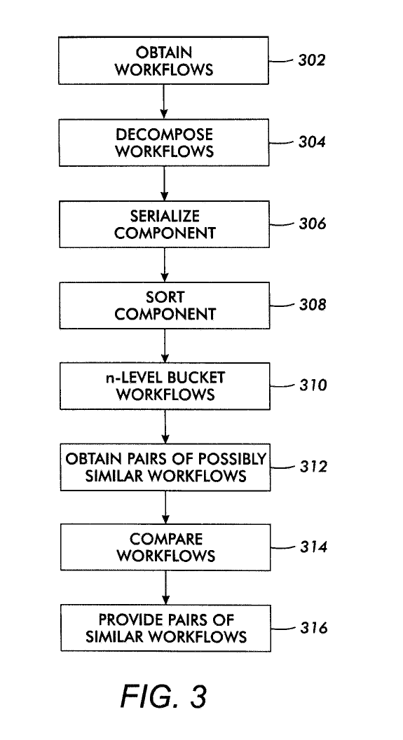

FIG. 2 is a schematic diagram of a workflow and its components. Workflow 202 includes tasks labeled “a”, “b”, “c”, and “d”. Workflow 202 also includes a start node, labeled “s”, and an end node, labeled “e”. Each of tasks a, b, c, and d represent activities that are part of workflow 202. Each arrow between any task in FIG. 3 represents an operation, e.g., a transition between tasks.

Workflow 202 includes several types of workflow components. Examples of a “workflow component” include the following types of workflow sub-graphs: splits, joins, and paths. For example, the sub-graph of workflow 202 that includes tasks a, d, and s and their intervening operations forms join component 204. As another example, the sub-graph of workflow 202 that includes tasks d, a, and e and their intervening operations forms split component 206. As yet another example, the sub-graph of workflow 202 that includes tasks a, b, c, and d together with their intervening operations form path component 208.

FIG. 3. is a flow chart of a method according to some embodiments. The method of FIG. 3 can be used to generate a similarity graph of a set of workflows. More particularly, the method of FIG. 3 can be used to thin out the number of computationally-intensive comparisons between pairs of workflows by eliminating from the comparison workflows that do not meet a threshold similarity comparison as detailed herein. The method of FIG. 3 can also be used to quickly determine whether a pair of workflows are not similar.

At block 302, the method obtains a set of workflows. The method can obtain the workflows by accessing stored representations of the workflows from a persistent memory, for example. As another example, the method can obtain the workflows by receiving electronic representations of them, e.g., over a network such as the internet.

At block 304, the method decomposes each workflow into components. In an example embodiment, the method decomposes each workflow into merge components, join components, and path components. The method can use known techniques for such decomposition.

At block 306, the method serializes the components resulting from the decompositions. More particularly, for each component of the decomposition, the method generates a pair consisting of a task sequence and a workflow identification. To serialize path components, the method prepends a dummy task, designated “$”, and then lists the tasks lexicographically, possibly omitting start task s and end task e. The method prepends the dummy task to the serialized components in order to differentiate path components, on the one hand, from split and merge components, on the other hand. To serialize split components, the method lists the split task first, and then lists the remaining tasks lexicographically. To serialize merge components, the method lists the merge task first, and then lists the remaining tasks lexicographically.

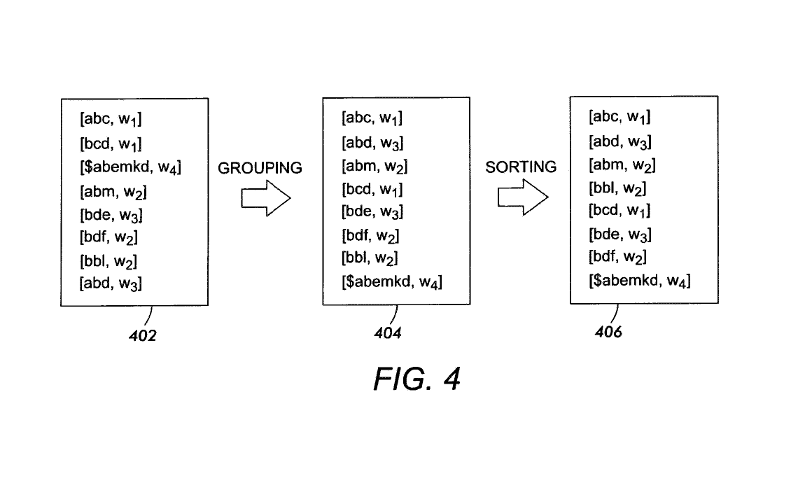

An example of such serialization is presented here in reference to components 104, 106, and 108 of FIG. 1. For purposes of illustration, assume that workflow 102 is designated as w₁. Thus, because path component 108 includes tasks a, b, c, and d, it can be serialized to the pair [$abcd, w₁]. Because merge component 104 includes merge task a, it can be serialized to [ade, w₁]. Because split component 106 includes split task d, it can be serialized as [dae, w₁]. Further examples are presented below in reference to FIG. 4.

At block 308, the method sorts the serialized components. The sorting can be as follows. First, the method sorts the serialized components according to leading task, then by length. Once the serialized components are grouped according to leading component and length, they are sorted within each group using a radix, e.g., lexicographic sort. An example of sorting according to block 308 is discussed in detail below in reference to FIG. 4.

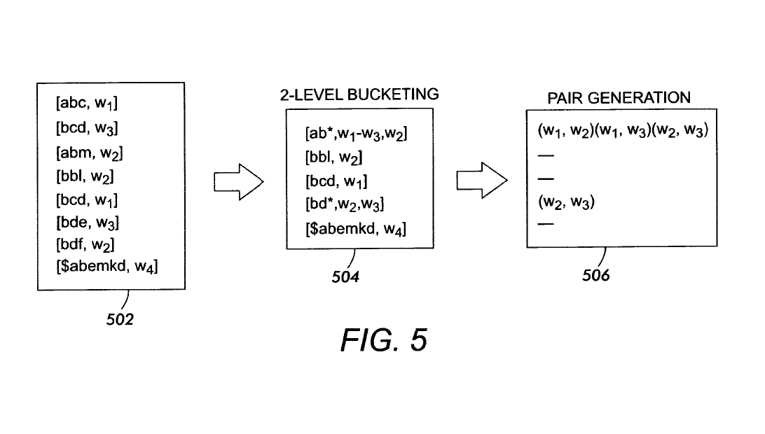

At block 310, the method n-level buckets the serialized, sorted workflows. Here, n-level bucketing means that the serialized, sorted components are grouped according to identical initial n-character segments. A divide-and-conquer approach can be used to this end. This stage can also include a further control on filtering pairs. For instance, the method may put [abc, w₁], [abd, w₂], [acd, w₂], [acm, w₃] into one bucket if a predefined similarity cutoff is relatively loose. Otherwise, the method may split them into two buckets: one containing [abc, w₁], [abd, w₂], and the other containing [acd, w₂], [acm, w₃]. A further example of 2-level bucketing is discussed below in reference to FIG. 5.

At block 312, the method identifies pairs of potentially similar workflows. The pairs are selected based on being in the same n-level bucket. For example, if serialized components [abc, w₁] and [abd, w₂] are sorted to be adjacent, then bucketed to arrive at the datum [ab*, w₁-w₂], then the method identifies the pair (w₁, w₂) as potentially similar workflows. An example identification is discussed below in reference to FIG. 5.

At block 314, the method performs a workflow comparison between the workflows paired at block 314. The comparison can be computationally intensive, because many pairs will be omitted by the preceding steps of the method. The comparison can be based on a similarity metric, in which workflows that are sufficiently similar according to the metric are indicated as being similar. Examples of algorithms for performing such comparisons include the following. As a first example, workflow comparison can be accomplished using label similarity comparison, in which the method computes an alignment between each pair of workflows. This technique can utilize a topological sort to detect the alignment. As a second example, workflow comparison can be accomplished using behavior similarity, in which workflows are compared by first representing them in n-grams based on execution paths. As a third example, workflow comparison can be accomplished using sub-graph isomorphism detection. In this approach, workflows are represented as directed graphs. This third technique can recursively partition workflows randomly into two segments when no shared segments are found in the working set. Alternately, this third technique can use an A* algorithm to calculate graph edit distance. In sum, block 314 can use any technique for comparing the workflows that remain once the technique of the prior blocks thins the set of possible comparisons.

At block 314, the method provides pairs of similar workflows. The method can do this in list form, or any alternate form. A particular example is a similarity graph, which presents the set of workflows as nodes in a graph, where an edge between nodes indicates similarity between the connected workflows.

FIG. 4 is a schematic diagram of applied processing steps according to some embodiments. Thus, list 402 of FIG. 4 depicts a collection of serialized components from four different workflows. Each serialized component is paired with an identification of the workflow from which it was derived. List 404 depicts the serialized components of list 402 grouped according to initial task and length. List 406 depicts the grouped serialized components of list 404 sorted within the groups of list 404 using a radix or lexicographic sort.

FIG. 5 is a schematic diagram of applied processing steps according to some embodiments. In particular, FIG. 5 depicts a continuation of the manipulation of the example workflow components of FIG. 3 according to a technique of the present invention. Thus, FIG. 5 first depicts list 502, which is identical to list 306 of FIG. 3. FIG. 5 next shows list 504, which depicts the serialized, grouped, and sorted components of list 502 2-level bucketed according to the techniques disclosed herein. For example the first entry of list 502 is the pair [ab*, w₁-w₃-w₂]. This indicates that three different workflow components from workflows w₁, w₃, and w₂, respectively, each contain serialized workflow components that begin with tasks a and b. The next entry of list 502 is a singleton, indicating that serialized workflow component bbl originating from workflow w₂ is not 2-bucketed with any serialized workflow component from any other workflow.

List 506 of FIG. 5 depicts workflow pairs designated as potentially similar according to the preceding steps. Each line on list 506 corresponds with a line in list 504. Thus, the first entry of list 506 indicates that workflows w₁, w₃, and w₂ are potentially similar. The next line of list 506 is null, indicating that the singleton appearing as the second entry of list 504 does not give rise to a similarity conclusion regarding the workflows.

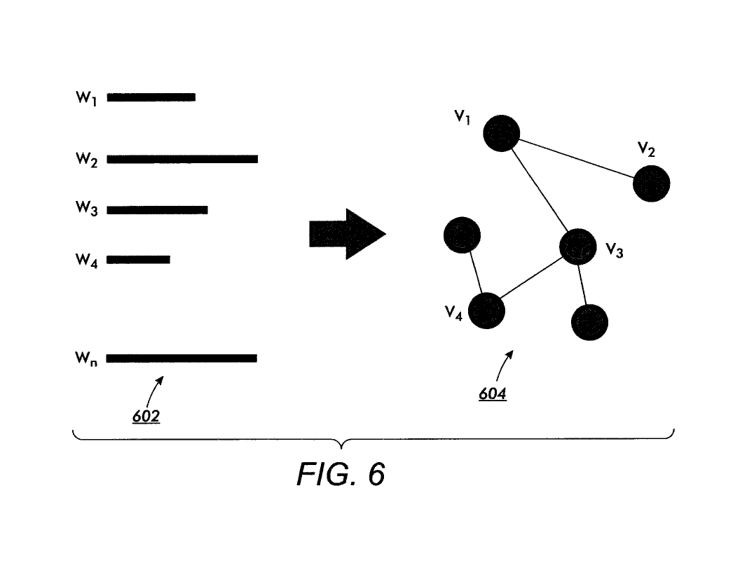

FIG. 6 is a schematic diagram of a workflow similarity graph. In particular, FIG. 6 depicts workflow similarity graph 604, which depicts similarity relationships between workflows. FIG. 6 depicts linear workflows 602 schematically. Workflow similarity graph 604 depicts each workflow as a node, with line segments between workflows representing that the connected workflows exceed a threshold similarity requirement.

Certain embodiments can be performed as a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A computer implemented method of detecting similar workflows, the method comprising:
obtaining a plurality of workflows, each workflow comprising a plurality of tasks and a plurality of operations;
decomposing each workflow into a plurality of components, each component comprising a plurality of tasks;
serializing each component into strings, each string comprising a sequence of tasks, whereby a plurality of serialized components are produced;
sorting the plurality of serialized components, whereby a plurality of sorted serialized components are produced;
n-level bucketing the plurality of serialized components, wherein n≧2, whereby a plurality of bucketed sorted serialized components are produced;
using the plurality of bucketed sorted serialized components to obtain a plurality of pairs of workflows;
comparing workflows in each pair of workflows to determine workflow similarity; and
providing pairs of similar workflows based on the comparing.

2. The method of claim 1, wherein the plurality of components comprise split components, merge components, and path components.

3. The method of claim 1, wherein the sorting comprises grouping the plurality of serialized components according to size.

4. The method of claim 1, wherein the sorting comprises radix sorting.

5. The method of claim 1, further comprising generating and displaying a workflow similarity graph based on the pairs of similar workflows.

6. The method of claim 1, wherein the comparing comprises utilizing a technique selected from: label similarity comparison, behavior similarity comparison, and sub-graph isomorphism detection.

7. The method of claim 1, wherein n=2.

8. The method of claim 1, wherein n=3.

9. The method of claim 1, further comprising recommending a historical efficient workflow based on the providing.

10. The method of claim 1, further comprising detecting a duplicative workflow.

11. A system for detecting similar workflows, the system comprising:
at least one processor configured to obtain a plurality of workflows, each workflow comprising a plurality of tasks and a plurality of operations;
at least one processor configured to decompose each workflow into a plurality of components, each component comprising a plurality of tasks;
at least one processor configured to serialize each component into strings, each string comprising a sequence of tasks, whereby a plurality of serialized components are produced;
at least one processor configured to sort the plurality of serialized components, whereby a plurality of sorted serialized components are produced;
at least one processor configured to n-level bucket the plurality of serialized components, wherein n≧2, whereby a plurality of bucketed sorted serialized components are produced;
at least one processor configured to use the plurality of bucketed sorted serialized components to obtain a plurality of pairs of workflows;
at least one processor configured to compare workflows in each pair of workflows to determine workflow similarity; and
at least one processor configured to provide pairs of similar workflows based on the comparing.

12. The system of claim 11, wherein the plurality of components comprise split components, merge components, and path components.

13. The system of claim 11, wherein the at least one processor configured to sort is further configured to group the plurality of serialized components according to size.

14. The system of claim 11, wherein the at least one processor configured to sort is further configured to radix sort.

15. The system of claim 1, further comprising at least one processor configured to generate a workflow similarity graph based on the pairs of similar workflows.

16. The system of claim 11, wherein the at least one processor configured to compare is further configured to utilize a technique selected from: label similarity comparison, behavior similarity comparison, and sub-graph isomorphism detection.

17. The system of claim 11, wherein n=2.

18. The system of claim 11, wherein n=3.

19. The system of claim 11, further comprising at least one processor configured to recommend a historical efficient workflow based on the providing.

20. The system of claim 11, further comprising at least one processor configured to detect a duplicative workflow.
